(19) United States
(12) Patent Application Publication
(10) Pub. No.: US 2026/0126511 A1
(43) Pub. Date: May 7, 2026

(54) Direction Finding Using a Single Electrically-Small Electromagnetic Field Sensing Device

(71) Applicant: The United States of America, as represented by the Secretary of the Navy, Arlington, VA (US)

(72) Inventors: Sergio A. Montoya, Chula Vista, CA (US); Benjamin J. Taylor, Escondido, CA (US)

(21) Appl. No.: 18/939,960

(22) Filed: Nov. 7, 2024

(51) Int. Cl. G01S 3/20

(52) U.S. Cl. CPC G01S 3/20

(57) ABSTRACT

A system for direction finding comprising: a single electrically-small radio frequency (ESRF) device configured to measure an amplitude of an incoming RF signal; a docking stage configured to rotate about a center axis, wherein the ESRF device is mounted to the docking stage such that with each rotation of the docking stage, the ESRF device passes through a plurality of discrete rotational positions so as to replicate a circular array of ESRF devices; and a processor configured to calculate an angle of arrival (AoA) of the incoming signal based on the measured amplitude of the incoming RF signal at each of the plurality of rotational positions.

### FEDERALLY-SPONSORED RESEARCH AND DEVELOPMENT

The United States Government has ownership rights in the invention claimed herein. Licensing and technical inquiries may be directed to the Office of Research and Technical Applications, Naval Information Warfare Center Pacific, Code 72110, San Diego, CA, 92152; voice (619) 553-5118; NIWC_Pacific_T2@us.navy.mil. Reference Navy Case Number 108774.

### BACKGROUND OF THE INVENTION

Common methods to determine the angle of arrival (AoA) of a radio frequency (RF) signal employ the use of at least two RF devices that are separated by a distanced commonly referred as the baseline. Interferometry-based AoA systems commonly look at phase differences of an RF signal received on at least two RF devices at different moments in time. Since the phase difference can only be made with respect to 2π, there is an inherent ambiguity in the calculated AoA along certain axes. To resolve this, more RF devices are frequently used, which may be arranged in various dimensions, to increase the angle fidelity at the expense of increased computational operations. There is a need for an improved direction finding device.

### SUMMARY

Described herein is an embodiment of a system for direction finding comprising an electrically-small radio frequency (ESRF) device, a docking stage, and a processor. The ESRF device is configured to measure an amplitude of an incoming RF signal. The docking stage is configured to rotate about a center axis. The ESRF device is mounted to the docking stage such that with each rotation of the docking stage, the ESRF device passes through a plurality of discrete rotational positions so as to replicate a circular array of ESRF devices. The processor is configured to calculate an AoA of the incoming signal based on the measured amplitude of the incoming RF signal at each of the plurality of rotational positions.

Also disclosed herein is a method for direction finding using a single ESRF device comprising the following steps. One step provides for mounting the ESRF device to a docking stage that is configured to rotate about a z-axis. Another step provides for rotating the docking stage about the z-axis at a rotational speed optimized to facilitate detection of RF signals within a desired frequency bandwidth. Another step provides for monitoring an amplitude of an incoming signal at N rotational positions during each revolution of the docking stage so as to generate at least N samples thereby replicating a circular array of ESRF devices. Another step provides for calculating an AoA of the incoming signal based on the at least N samples.

### BRIEF DESCRIPTION OF THE DRAWINGS

Throughout the several views, like elements are referenced using like references. The elements in the figures are not drawn to scale and some dimensions are exaggerated for clarity.

FIG. 1A is a side-view illustration of an embodiment of a direction finding system using a single ESRF device.

FIG. 1B is a perspective-view illustration of an embodiment of a direction finding system using a single ESRF device.

FIG. 2A is a stop-view illustration of an embodiment of a direction finding system using a single ESRF device.

FIGS. 2B, 2C, and 2D are top-view illustrations of an ESRF device at three different time steps.

FIG. 3A is a side-view illustration of an embodiment of a direction finding system on a mobile platform.

FIG. 3B is a side-view illustration of an embodiment of a direction finding system on a stationary platform.

FIG. 4 is a flowchart of a method for direction finding using a single ESRF device.

### DETAILED DESCRIPTION OF EMBODIMENTS

The disclosed methods and systems below may be described generally, as well as in terms of specific examples and/or specific embodiments. For instances where references are made to detailed examples and/or embodiments, it should be appreciated that any of the underlying principles described are not to be limited to a single embodiment, but may be expanded for use with any of the other methods and systems described herein as will be understood by one of ordinary skill in the art unless otherwise stated specifically.

References in the present disclosure to “one embodiment,” “an embodiment,” or any variation thereof, means that a particular element, feature, structure, or characteristic described in connection with the embodiments is included in at least one embodiment. The appearances of the phrases “in one embodiment,” “in some embodiments,” and “in other embodiments” in various places in the present disclosure are not necessarily all referring to the same embodiment or the same set of embodiments.

As used herein, the terms “comprises,” “comprising,” “includes,” “including,” “has,” “having,” or any variation thereof, are intended to cover a non-exclusive inclusion. For example, a process, method, article, or apparatus that comprises a list of elements is not necessarily limited to only those elements but may include other elements not expressly listed or inherent to such process, method, article, or apparatus. Further, unless expressly stated to the contrary, “or” refers to an inclusive or and not to an exclusive or.

Additionally, use of words such as “the,” “a,” or “an” are employed to describe elements and components of the embodiments herein; this is done merely for grammatical reasons and to conform to idiomatic English. This detailed description should be read to include one or at least one, and the singular also includes the plural unless it is clearly indicated otherwise.

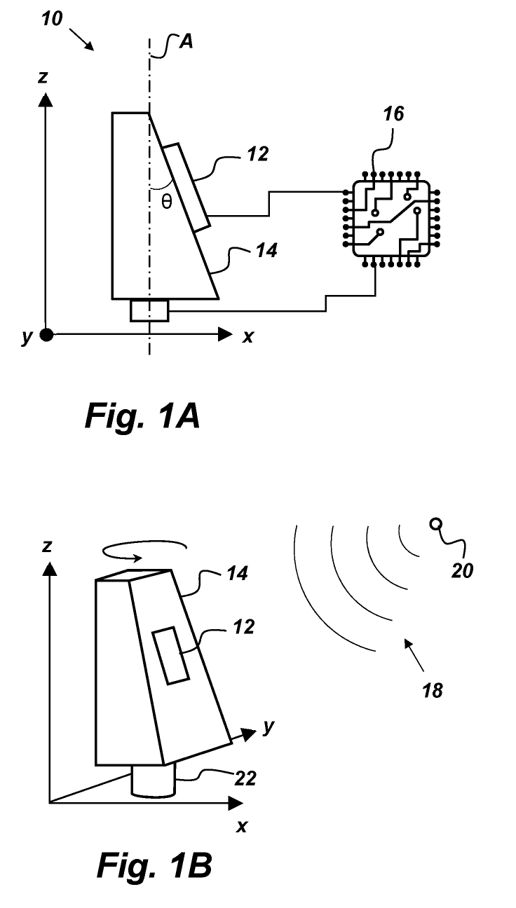

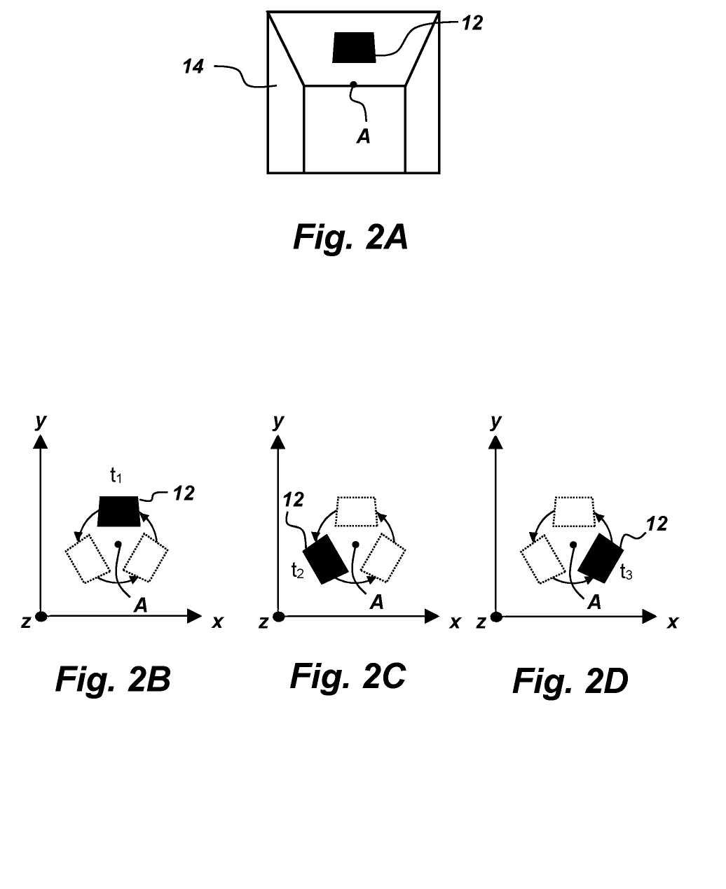

FIGS. 1A and 1B are respectively side-view and perspective-view illustrations of an embodiment of a direction finding system 10 that comprises, consists of, or consists essentially of an ESRF device 12, a docking stage 14, and a processor 16. The direction finding system 10 is able to rotate the single ESRF device 12 to perform AoA operations with respect to an incoming RF signal 18. The ESRF device 12 is configured to measure an amplitude of the incoming RF signal 18. The docking stage 14 is configured to rotate about a center axis A. In the embodiment of the direction finding system 10 shown in FIGS. 1A and 1B, the the ESRF device 12 is mounted to the docking stage 14 at an oblique angle θ to the center axis A such that with each rotation of the docking stage 14, the ESRF device 12 passes through a plurality of discrete rotational positions so as to replicate a circular array of ESRF devices. The ESRF device 12 is mounted to the docking stage 14 in such a manner that the docking stage 14 does not interfere with the ability of the ESRF device 12 to detect the incoming RF signal 18. The processor 16 is configured to calculate the AoA of the incoming RF signal 18 based on the measured amplitude of the incoming RF signal 18 at each of the plurality of rotational positions. For example, measuring amplitude of the incoming RF signal 18 with the ESRF device 12 at one-degree interval steps along the rotational path (see rotational path 26 shown in FIGS. 2B, 2C, and 2D) is the same as capturing amplitude measurement information from 360 separate elements.

The direction finding system 10 is able to determine the 3-dimensional angle of AoA (i.e., elevation and azimuth) of the incoming RF signal 18 emanating from an RF source 20. The docking stage 14 may be rotated by a rotator 22 (e.g., electric, pneumatic, hydraulic, hand crank, etc.). By rotating the ESRF device 12, one may capture all relevant components of a linearly polarized RF signal and using field component-based techniques determine the direction from where the RF signal 18 is being emitted. An interferometry-based model may also be used to determine the AoA from circularly polarized RF signals of sufficient time duration with relatively long wavelengths compared to the size of the ESRF device 12 and the length of the circular perimeter the ESRF device travels in one rotation period of the docking stage 14. It is preferable that the processor 16 be communicatively coupled with the rotator 22 such that the rotational speed is communicated to the processor 16. The processor 16 may also be configured to control the rotation speed of rotator 22. The docking stage 14 and rotator 22 may be mounted to a platform 24 that may be stationary or mobile. The only information known to the processor 16 when calculating the AoA are the dimensions of the ESRF device 12 and the docking stage 14 as well as the rotational speed of the docking stage 14. Although the embodiment of the direction finding system 10 depicted in FIGS. 1A and 1B relates to RF signals, it is to be understood that the direction finding system 10 is not limited to RF, but may be used for direction finding of a signal having a frequency considered to be outside of the RF range, such as electromagnetic emissions from motors, electronics, turbines, etc.

Ideally, the direction finding system 10 should be used for direction finding of electromagnetic signals of sufficient duration in time and/or also having a stable feature such as a pilot tone that can be used to determine the amplitude of the magnetic (or electric) field components, Bx, By, Bz (Ex, Ey, Ez). For example, a frequency hopping signal would be extremely difficult to perform AoA by sampling different positions in space at different times with a single sensor such as shown in FIG. 1A. Alternative embodiments of the direction finding system 10 may involve two or more ESRF devices placed on the docking stage 14, in which embodiments, one could enhance the AoA determination of an incoming signal via standard phase-based interferometry by rotating the two or more ESRF devices according to the methodology disclosed herein.

Referring back to the embodiment of the direction finding system 10 portrayed in FIGS. 1A and 1B, one may determine average values all three field components (i.e., x, y, and z vectors in a three orthogonal axis coordinate system) of the incoming signal 18 using the rotating geometry, but with measurements made at different times. Preferably, the incoming signal 18 should be stable in nature, originating from a slow or stationary platform, and not of an elusive type such as Low Probability of Intercept (LPI) and Low Probability of Detection (LPD) RF signals. Embodiments of the direction finding device 10 may be used operationally for surveying and pin-pointing sources of electromagnetic emissions from a variety of sources. In some embodiments of the direction finding system 10, the ESRF device 12 is physically connected to the processor 16 and the processor 16 may be connected (e.g., optically or electrically) to a receiver system (not shown) and a power source (not shown) in such a way that the docking stage 14 is not allowed to rotate continuously in one direction, but alternates rotational directions. In other embodiments, the processor 16 may be mounted within the docking stage 14 with integrated batteries and wirelessly connected to a receiver such that the docking stage 14 could rotate continuously in a single direction.

FIGS. 2A, 2B, 2C, and 2D are top-view illustrations of an embodiment of the direction finding system 10. FIGS. 2B, 2C, and 2D show the position of the ESRF device 12 at three different time steps (t₁, t₂, and t₃). In an example operational scenario, assume that electromagnetic radiation (i.e., the incoming RF signal 18) is emitted from the RF source 20, which signal travels in the direction where the direction finding system 10 is located. Assuming the ESRF device 12 is sensitive only along a single plane (x, y, or z-axis), then the RF device 12 is positioned at an angled profile to facilitate capturing the incoming RF signal 18 along any direction in three dimensional space.

The docking stage 14 may be rotated about the normal center-line axis A in either a clockwise or counter-clockwise direction. FIGS. 2B, 2C, and 2D show the ESRF device 12 rotating in a counter-clockwise direction. The rotation speed may be optimized to facilitate the detection of RF signals of specific frequency bandwidths. In general, the speed of rotation can be slower for RF signals with wavelengths relatively large compared to the size of the ESRF device 12 and the length of the circular perimeter the ESRF device travels in one rotation period of the docking stage 14 (e.g., rotational path 26 shown in FIGS. 2B, 2C, and 2D). By continuously rotating the docking stage 14 and the RF device 12 mounted to it, one can collect at least N-number of samples (i.e., amplitude measurements of the incoming RF signal), where N represents the number of discrete points/locations along the rotational path 26. More than one sample may be taken at each of the N locations to improve signal-to-noise ratio and build sufficient statistics to properly determine the AoA. Given the position of the ESRF device 12 is not fixed, the AoA is not determined through traditional phase-differences detected using two RF devices. Instead, the processor 16 utilizes variations in the amplitude signal in at the different points along the rotational path 26 to determine the AoA of the incoming RF signal 18.

The ESRF device 12 may be any device capable of measuring the amplitude of the incoming RF signal 18 and sensitive to the electric or magnetic field component in a fixed direction with respect to the geometry of the surface on which it is placed. For example, in the case where the ESRF device 12 is a superconducting quantum interference device (SQUID) array, the array is sensitive to the magnetic field component perpendicular to the surface, however, a fiber-optic vector magnetic field sensor would be sensitive to the magnetic field in the plane of the surface. A sensor that measures the total power amplitude of a signal would not be preferred for AoA/direction finding. Suitable examples of the ESRF device 12 include, but are not limited to, magnetoelectric composites, magneto-strictive based fiber-optic vector magnetic field sensors, spin torque magnetic field sensor, electric-field microfiber interferometers, and SQUID arrays. The docking stage 14 may be any structure capable of supporting the ESRF device 12 while rotating about the centerline axis A.

Ideally, the processor 16 would be compact, high-speed, and have sufficiently large memory. In some embodiments, the processor 16 may be chip-scale and integrated into the docking stage 14. If integrated the processor 16 would need to be able to operate under the conditions in which the ESRF device 12 operates (e.g., in a vacuum, at low temperatures, as appropriate). In some embodiments, the processor 16 may require optical inputs, or could be an optical-based processor, as appropriate to the ESRF device 12 selected. In embodiments of the direction finding system 10 where the processor 16 is not integrated into the docking stage 14, the processor could be much larger such as a blade server type capacity with the appropriate RF or optical connectivity. In some embodiments, the processor 16 may need to have access to a library of algorithms to apply to the signal collection process. For instance, it may be desirable to hold the rotational position fixed for sufficient time to characterize the class of signal, and then to select the appropriate algorithm for sampling and for direction finding calculation.

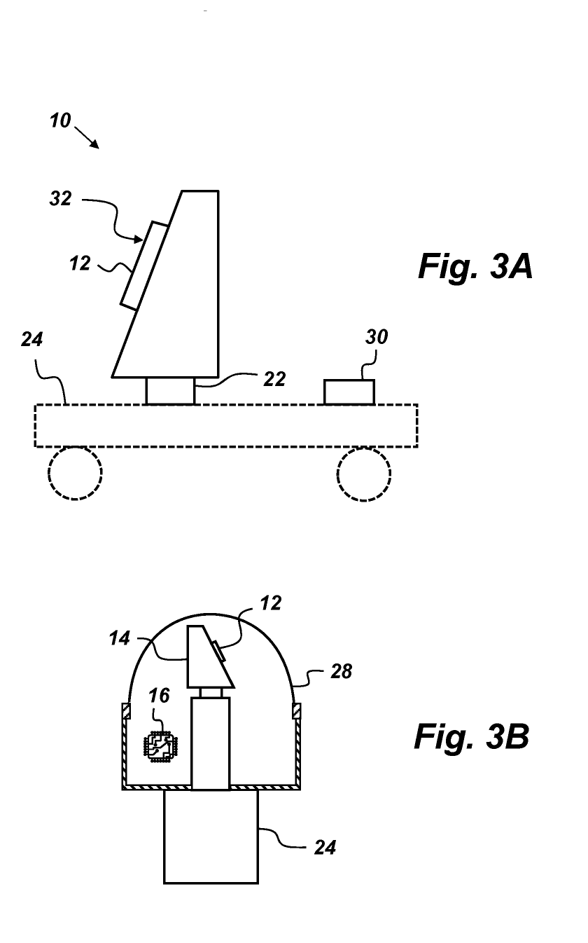

FIGS. 3A and 3B are both side-view illustrations of different embodiments of the direction finding system 10 mounted on different platforms 24. In FIG. 3A, the direction finding system 10 is mounted on a mobile embodiment of the platform 24. The direction finding device 10 may be applied to ESRF devices designed to operate in ambient or cryogentic environments. For example, in FIG. 3B, the direction finding system 10 is mounted within a cryogenic environment 28 (e.g., within a cryocooler, mounted on a cold finger, etc.) on a stationary embodiment of the platform 24. The ESRF device 12 can be designed to be sensitive to the electric or magnetic field component of electromagnetic radiation emitted from the RF source 20. The embodiment of the direction finding system 10 shown in FIG. 3A further comprises an active field source 30 (e.g., coil-type source) configured to generate a magnetic field to compensate for the ESRF’s motion through a surrounding magnetic background (e.g., Earth’s magnetic field) so as to keep a magnetic field at a surface 32 of the ESRF device 12 at a constant value. The ESRF device 12 may be tuned to receive the incoming RF signal 20 from an RF source 20 of particular interest. In embodiments of the direction finding system 10 where the platform 24 is stationary, it may be sufficient for the background magnetic field to be sampled once or periodically to determine the field components as a function of rotational position of the ESRF device 12, and then use calculated values for background field compensation. Embodiments of the direction finding system 10 that are mounted to a non-stationary platform 24, an active field compensation feedback loop may be used to compensate for movement through a surrounding magnetic field. The surrounding magnetic field may be sampled by the ESRF device 12, depending on its type, or independently by an additional sensor operatively coupled to the processor 16.

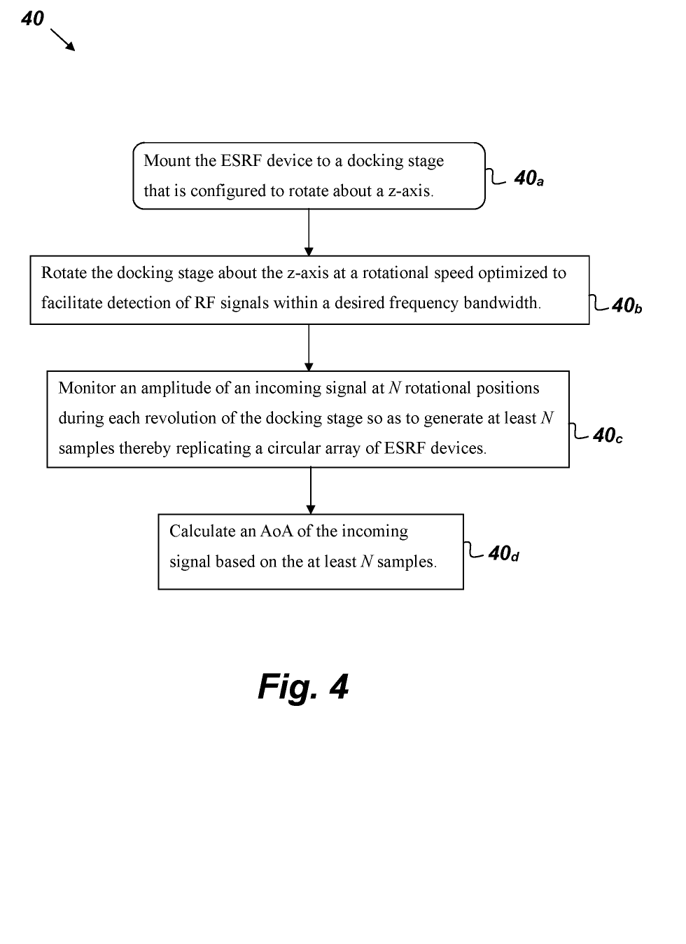

FIG. 4 is a flowchart of a method 40 for direction finding using a ESRF device comprising the following steps. The first step 40ₐ provides for mounting the ESRF device to a docking stage that is configured to rotate about a z-axis. The ESRF device is mounted at an oblique angle to the z-axis. Another step 40_{b} provides for rotating the docking stage about the z-axis at a rotational speed optimized to facilitate detection of RF signals within a desired frequency bandwidth. Another step 40_{c} provides for monitoring an amplitude of an incoming signal at N rotational positions during each revolution of the docking stage so as to generate at least N samples thereby replicating a circular array of ESRF devices. Another step 40_{d} provides for calculating an AoA of the incoming signal based on the at least N samples.

From the above description of the direction finding system and method using a ESRF device, it is manifest that various techniques may be used for implementing the concepts of system 10 and method 40 without departing from the scope of the claims. The described embodiments are to be considered in all respects as illustrative and not restrictive. The method/apparatus disclosed herein may be practiced in the absence of any element that is not specifically claimed and/or disclosed herein. It should also be understood that system 10 and method 40 are not limited to the particular embodiments described herein but is capable of many embodiments without departing from the scope of the claims.

We claim:

1. A system for direction finding comprising:
a single electrically-small radio frequency (ESRF) device configured to measure an amplitude of an incoming RF signal;
a docking stage configured to rotate about a center axis, wherein the ESRF device is mounted to the docking stage such that with each rotation of the docking stage, the ESRF device passes through a plurality of discrete rotational positions so as to replicate a circular array of ESRF devices; and
a processor configured to calculate an angle of arrival (AoA) of the incoming signal based on the measured amplitude of the incoming RF signal at each of the plurality of rotational positions.

2. The system for direction finding of claim 1, wherein the ESRF device is mounted to the docking stage at an oblique angle to the center axis.

3. The system for direction finding of claim 2, wherein the docking stage is mounted to a stationary platform.

4. The system for direction finding of claim 1, further comprising an active field source configured to generate a magnetic field to compensate for the ESRF’s motion through a surrounding magnetic background.

5. The system for direction finding of claim 4, wherein the surrounding magnetic background is Earth’s magnetic field.

6. The system for direction finding of claim 5, wherein the system is fixed within a cryogenic environment.

7. The system for direction finding of claim 5, wherein the ESRF is tuned to receive the incoming RF signal from a particular RF source of interest.

8. The system for direction finding of claim 7, wherein ESRF is tuned to be sensitive to a magnetic field component of the incoming RF signal.

9. The system for direction finding of claim 1, wherein the incoming RF signal is circularly polarized and the processor is configured to use an interferometry-based model to calculate the AoA.

10. A method for direction finding using a single electrically-small radio frequency (ESRF) device comprising:
mounting the ESRF device to a docking stage that is configured to rotate about a z-axis, rotating the docking stage about the z-axis at a rotational speed optimized to facilitate detection of RF signals within a desired frequency bandwidth;
monitoring an amplitude of an incoming signal at N rotational positions during each revolution of the docking stage so as to generate at least N samples thereby replicating a circular array of ESRF devices; and
calculating an angle of arrival (AoA) of the incoming signal based on the at least N samples.

11. The method for direction finding of claim 10, wherein the incoming RF signal is a linearly polarized RF signal.

12. The method for direction finding of claim 11, wherein the docking stage is mounted to a stationary platform.

13. The method for direction finding of claim 12, further comprising a magnetic field generating element with an active field source to compensate for the ESRF’s motion through a surrounding magnetic background so as to keep a magnetic field at a surface of the ESRF at a constant value.

14. The method for direction finding of claim 13, wherein the surrounding magnetic background is Earth’s magnetic field.

15. The method for direction finding of claim 14, further comprising mounting the docking stage within a cryogenic environment.

16. The method for direction finding of claim 15, wherein the ESRF is tuned to receive the incoming RF signal from a particular RF source of interest.

17. The method for direction finding of claim 10, wherein the incoming RF signal is circularly polarized and further comprising using an interferometry-based model with the processor to calculate the AoA.

18. The method for direction finding of claim 10, wherein N is equal to three.

19. The method for direction finding of claim 10, wherein N is equal to 360.

20. The method for direction finding of claim 10, wherein the monitoring step comprises generating at least 2N samples such that two amplitude measurements are collected at each rotational location, and the AoA is calculated based on the 2N samples.
